(19) United States
(12) Patent Application Publication
(10) Pub. No.: US 2008/0080599 A1
(43) Pub. Date: Apr. 3, 2008

(54) HETERODYNE RF TRANSCEIVER FOR RADAR SENSOR

(76) Inventors: Dong Min KANG, Daejeon (KR); Ju Yeon HONG, Seoul (KR); Jae Yeob SHIM, Daejeon (KR); Hyung Sup YOON, Daejeon (KR); Kyung Ho LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/737,828

(22) Filed: Apr. 20, 2007

(30) Foreign Application Priority Data
Sep. 29, 2006 (KR) 2006-95400

(51) Int. Cl. H04B 1/38

(52) U.S. Cl. 375/219; 375/E07.001

(57) ABSTRACT

Provided is an RF transceiver for a 77 GHz forward-looking radar sensor. The RF transceiver whose essential components use a Monolithic Microwave Integrated Circuit (MMIC) includes an IF terminal including a transmitter, a receiver, and an Automatic Gain Control (AGC) circuit, one transmitting antenna, and three receiving antennas.

The heterodyne RF transceiver for a radar sensor includes; a transmitter for generating a transmission signal and emitting the generated signal to a transmitting antenna; a local oscillating portion for generating a local oscillation wave; a first mixer for up-mixing the transmission signal with the low frequency; a receiver for receiving a reception signal from a receiving antenna; a second mixer for down-mixing a mixing signal of the first mixer with the reception signal; and an RF portion for outputting a beat signal from a mixing signal of the second mixer and the local oscillation wave.

In the RF transceiver, a heterodyne method using an intermediate frequency (IF) signal is applied, and one AGC circuit and three receiving antennas for enhancing receive sensitivity are used, so that the receive sensitivity is improved by 30 dB or more compared with a conventional RF transceiver using a homodyne method.

### CROSS-REFERENCE TO RELATED APPLICATION

This application claims priority to and the benefit of Korean Patent Application No. 2006-0095400, filed Sep. 29, 2006, the disclosure of which is incorporated herein by reference in its entirety.

### BACKGROUND

1. Field of the Invention

The present invention relates to a radio frequency (RF) transceiver for a 77 GHz forward-looking radar sensor, and more particularly, to a heterodyne RF transceiver using an intermediate frequency (IF) rather than a conventional homodyne RF transceiver.

2. Discussion of Related Art

An RF transceiver for a forward-looking radar sensor of the present invention is disposed at the front end of the radar sensor, and is an essential part that is responsible for wireless communication. Further, sensitivity of the RF transceiver is a very important element in determining effective distance of the radar sensor. To increase the effective distance, the sensitivity of the RF transceiver should be improved.

Generally, the RF transceiver for the radar sensor includes a signal source using a Voltage Controlled Oscillator (VCO), a transmitter for emitting transmission modulation power, and a receiver for transmitting a received signal. By means of a divider, one of the transmission modulation (TM) signals transmitted from the transmitter is externally emitted as a carrier wave through a transmitting antenna and the other is input to a mixer of the receiver as a local oscillation wave.

Due to the sensitivity of this homodyne transceiver, the TM signal has an effect on the reception signal. As a result, isolation characteristics of the receiver can deteriorate, and thus it is impossible for a radar sensor to attain high sensitivity reception.

### SUMMARY OF THE INVENTION

The present invention is directed to a heterodyne RF transceiver capable of improving its performance in terms of sensitivity.

One aspect of the present invention provides a heterodyne RF transceiver for a radar sensor including: a transmitter for generating a transmission signal and emitting the generated signal to a transmitting antenna; a local oscillating portion for generating a local oscillation wave; a first mixer for up-mixing the transmission signal with the local oscillation wave; a receiver for receiving a reception signal from a receiving antenna; a second mixer for down-mixing a mixing signal of the first mixer with the reception signal; and an RF portion for outputting a beat signal from a mixing signal of the second mixer and the local oscillation wave.

In the RF transceiver for the 77 GHz forward-looking radar sensor of the present invention, after a frequency of the local oscillation wave is once more converted using an up-mixer and an intermediate frequency (IF), the converted local oscillation wave is transmitted to the down-mixer of the receiver so that the transmission modulation (TM) signal is used separately from the local oscillation wave of the receiver. Also, a band-pass filter is included in the local oscillation wave of the receiver so that the TM signal is completely separated in order to have no effect on the reception signal, which results in improved isolation. Further, an Automatic Gain Control (AGC) circuit is inserted into an IF terminal so as to automatically adjust the gain of a received signal that is to be increased when the reception signal is very weak. In addition, three antennas are used in the receiver to improve receiving rate.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates a configuration of an RF transceiver for a 77 GHz forward-looking radar sensor according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

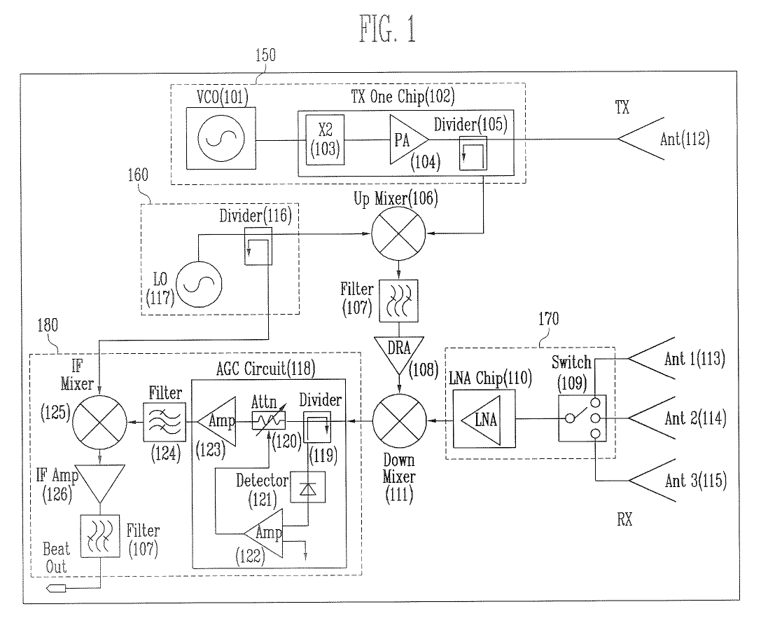

FIG. 1 illustrates a configuration of an RF transceiver for a 77 GHz forward-looking radar sensor according to an exemplary embodiment of the present invention. The RF transceiver includes a signal source voltage controlled oscillator (VCO) 101 having a modulation bandwidth of 150 MHz at 38.25 GHz and an output power of 5 dBm, and a one-chip for transmission 102 disposed at an output terminal of the VCO 101. The one-chip for transmission 102 includes a frequency doubler 103 for multiplying a base frequency of 38.25 GHz by two to generate a harmonic frequency of 76.5 GHz, and a power amplifier 104 disposed at an output terminal of the frequency doubler for amplifying power.

Also, a divider 105 is disposed at an output terminal of the power amplifier 104 to divide the power, and one of outputs of the divider 105 is arranged to be transferred to a transmitting antenna 112, and the other of the outputs is arranged to be transferred to an up-mixer 106.

The VCO 101, the frequency doubler 103, the power amplifier 104, and the divider 105 constitute a transmitter 150 of the radar sensor.

In addition, a band-pass filter 107 is disposed at an output terminal of the up-mixer 106, a driver amplifier 108 is disposed at an output terminal of the band-pass filter 107, and an output terminal of the driver amplifier 108 is connected to a local oscillator (LO) terminal of a down-mixer 111 of a receiver.

In the receiver 170, signals received by three receiving antennas 113, 114 and 115 are transmitted to a switch 109 connected to output terminals of the receiving antennas 113, 114 and 115. Then, the signals are transmitted to a low noise amplifier 110 to be amplified, and transmitted to an RF terminal of the down-mixer 111.

In an intermediate frequency (IF) portion 180, a signal having a frequency band of 1.5 GHz is generated from an local oscillator 117, and a divider 116 is arranged at an output terminal of the LO 117 so that one of two output terminals of the divider is connected to an IF terminal of the up-mixer 106, and the other of the output terminals is connected to an LO terminal of an IF mixer 125.

Moreover, an IF signal output from an IF output terminal of the down-mixer 111 automatically drives an Automatic Gain Control (AGC) circuit 118 to compensate for a gain of about 40 dB when a signal having a power of −70 dBm or less is input to an AGC circuit 118.

The AGC circuit 118 includes a signal strength detector 121 for detecting a power level of the output signal of the down-mixer 111, a variable attenuator 120 for attenuating the output signal of the down-mixer 111 according to a detected signal of the signal strength detector 121, and a gain amplifier 123 for amplifying an output signal of the variable attenuator.

Then, a signal from the AGC circuit 118 is input into an RF terminal of the IF mixer 125 through a band-pass filter 124. A signal of the IF output terminal of the IF mixer 125 is transferred to an input terminal of an IF amplifier 126, and a beat signal output from an output terminal of the IF amplifier 126 is input into a digital signal processors (DSP) of the radar sensor through a band-pass filter 127.

Detailed operations of the transceiver are described below.

The VCO 101 is a signal source that has a modulation bandwidth of 150 MHz at 38.25 GHz and an output power of 5 dBm, and is fabricated using a Monolithic Microwave Integrated Circuit (MMIC) or a Gunn Diode. Here, a modulated and oscillated transmission signal is transmitted to the one-chip for transmission 102, in which the frequency doubler 103 doubles a frequency of the input modulated and oscillated transmission signal.

The frequency doubler 103 of the present invention is fabricated with the MMTC, and has an input frequency (fo) of 38 to 38.5 GHz and an output frequency (2fo) of 76 to 77 GHz. The frequency doubler 103 should be excellent in suppression characteristics, and input and output matching characteristics of the fo (38 to 38.5 GHz) with respect to the 2fo (76 to 77 GHz).

The transmission signal multiplied as above is input into the power amplifier 104 to compensate for the conversion loss of the frequency multiplier 103 and amplify the power. The power amplifier 104 that can be implemented with the MMIC has an output power of 13 dBm. This is because the output power specification of a radar sensor should not exceed 10 dBm. Also, the divider 105 is arranged at the output terminal of the power amplifier to divide the power, and an insertion loss of the divider is about 3 dB.

Further, one of the outputs of the divider 105 with an output power of 10 dBm is transmitted to the transmitting antenna 112 and is emitted. Here, the transmitting antenna 112 may employ a patch array antenna. Unlike a homodyne transceiver, the other output is not directly transmitted to the down-mixer 111 of the receiver, but is input into an LO terminal of the up-mixer 106 to separately use the transmission signal from an LO of the receiver.

A 1.5 GHz oscillation signal of the LO 117 is input to the IF terminal of the up-mixer 106. After an output signal of the LO terminal with 77.5 to 78.5 GHz that is up-converted by the up-mixer 106 is transmitted to the band-pass filter 107 to completely separate a transmission modulation signal from a reception signal, the signal is amplified by the driver amplifier 108 to compensate for the conversion loss of the mixer, and then transmitted to an LO of the down-mixer 111 of the receiver.

In the receiver 170, signals received by three receiving antennas 113, 114 and 115 are transmitted to a switch 109 connected to output terminals of the receiving antennas 113, 114 and 115. Then, the signals are transmitted to a low noise amplifier 110 to be amplified, and transmitted to an RF terminal of the down-mixer 111.

The signals transmitted to an RF terminal of the down-mixer 111 have a frequency band of 76+ df to 77+ df GHz and the signals are mixed with an local oscillation signal having a frequency band of 77.5 to 78.5 GHz transmitted from the LO terminal of the down mixer 111. As a result of the mixing, an IF signal of 1.5+ df GHz is generated and the generated signal is transmitted to the AGC circuit 118. Here, df denotes a receive frequency shift according to the Doppler Effect.

When the AGC circuit 118 detects a received signal having a power of −70 dBm or less, the AGC circuit 118 automatically compensates for a gain of about 40 dB.

The AGC circuit 118 includes a signal strength detector 121, a variable attenuator 120 and a gain amplifier 123. A signal strength detector 121 detects a power level of the output signal of the down-mixer 111 and a variable attenuator 120 attenuates the output signal of the down-mixer 111 according to a detected signal of the signal strength detector 121, and a gain amplifier 123 amplifies an output signal of the variable attenuator 120.

Then the signal is transmitted to the IF band-pass filter 124. The IF signal that passes through the filter is transmitted to the RF terminal of the IF mixer 125, and a 1.5 GHz local oscillation signal transmitted from the FO 117 having a frequency band of 1.5 GHz is transmitted to the LO terminal of the IF mixer 125. A (1.5− df GHz)−1.5 GHz beat signal that is converted by the IF mixer 125 passes through the IF amplifier 126 and the band-pass filter 127 and is transmitted to a DSP.

According to an RF transceiver for a radar sensor of the present invention, it is possible to improve receive sensitivity.

More specifically, the RF transceiver for a radar sensor of the present invention can increase the sensitivity by 30 dB or more at 76 to 77 GHz compared with a conventional homodyne RF transceiver.

In other words, in the RF transceiver of the present invention, a transmission modulation signal is separately used from a reception LO using an up-mixer and an IF of a conventional LO between a transmitter and a mixer of a receiver. Also, a band-pass filter for preventing the transmission modulation signal from having an effect on the receiver is included in the LO of the receiver. Further, a power level of a received signal is automatically controlled using an AGC circuit of an IF terminal. Moreover, three receiving antennas are used to improve a receiving rate, so that the sensitivity is improved by 30 dB or more.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A heterodyne RF transceiver for a radar sensor, comprising:
a transmitter for generating a transmission signal and emitting the generated signal to a transmitting antenna;
a local oscillating portion for generating a local oscillation wave;
a first mixer for up-mixing the transmission signal with the local oscillation wave;
a receiver for receiving a reception signal from a receiving antenna;
a second mixer for down-mixing a mixing signal of the first mixer with the reception signal; and
an RF portion for outputting a beat signal from a mixing signal of the second mixer and the local oscillation wave.

2. The heterodyne RF transceiver of claim 1, wherein the transmitter comprises:
a voltage controlled oscillator (VCO) for generating a basic oscillation signal;
a frequency doubler for multiplying a frequency of the basic oscillation signal;
a power amplifier for amplifying an output signal of the frequency doubler; and
a divider for dividing an output signal of the power amplifier into signals to be transferred to the transmitting antenna and the first mixer.

3. The heterodyne RF transceiver of claim 1, wherein the receiver comprises:
a selection switch for selecting one of signals received from two or more receiving antennas; and
a low noise amplifier for amplifying the reception signal selected by the selection switch.

4. The heterodyne RF transceiver of claim 1, further comprising:
a band-pass filter for filtering an output signal of the first mixer; and
a driver amplifier for amplifying an output signal of the band-pass filter and transferring the amplified signal to the second mixer.

5. The heterodyne RF transceiver of claim 1, wherein the local oscillating portion comprises:
a local oscillator; and
a divider for dividing an oscillation signal of the local oscillator into signals to be transferred to the first mixer and the RF portion.

6. The heterodyne RF transceiver of claim 1, wherein the RF portion comprises:
an Automatic Gain Control (AGC) circuit for performing an amplification operation depending on a power level of the output signal of the second mixer;
a IF mixer for mixing an output signal of the AGC circuit with the local oscillation wave; and
an IF amplifier for amplifying an output signal of the IF mixer, and outputting the amplified signal as the beat signal.

7. The heterodyne RF transceiver of claim 6, wherein the RF portion comprises:
a second band-pass filter for filtering the output signal of the AGC circuit; and
a third band-pass filter for filtering the output signal of the IF amplifier.

8. The heterodyne RF transceiver of claim 6, wherein the AGC circuit comprises:
a signal strength detector for detecting a power level of the output signal of the second mixer;
a variable attenuator for attenuating the output signal of the second mixer according to a detected signal of the signal strength detector; and
a gain amplifier for amplifying an output signal of the variable attenuator.
